(19) United States
(12) Patent Application Publication
(10) Pub. No.: US 2014/0284038 A1
(43) Pub. Date: Sep. 25, 2014

(54) HEAT EXCHANGER DESIGN AND FABRICATION

(71) Applicant: HAMILTON SUNDSTRAND CORPORATION, Windsor Locks, CT (US)

(72) Inventors: Venkata R. Vedula, Unionville, CT (US); Robert Telakowski, Windsor Locks, CT (US)

(73) Assignee: HAMILTON SUNDSTRAND CORPORATION, Windsor Locks, CT (US)

(21) Appl. No.: 13/848,356

(22) Filed: Mar. 21, 2013

(51) Int. Cl. F28F 3/02; B23P 15/26

(52) U.S. Cl. CPC F28F 3/02; B23P 15/26
USPC 165/185; 29/890.03

(57) ABSTRACT

A method of forming a heat exchanger for use with a rotating component configured to rotate about an axis of rotation is provided including generating a stereolithography file of the surface geometry of the heat exchanger. The surface geometry of the heat exchanger includes a cylindrical base having a plurality of fins extending generally radially therefrom. The surface geometry defined in the stereolithography file is ‘sliced’ into a plurality of axisymmetric layers, perpendicular to the axis of rotation. Energy from an energy source is applied to a powdered material causing the powdered material to fuse and form the plurality of axisymmetric thin layers. Each of the axisymmetric thin layers is integrally formed with an adjacent axisymmetric thin layer to create a unitary heat exchanger.

### BACKGROUND OF THE INVENTION

Exemplary embodiments of this invention generally relate to heat exchangers and, more particularly, to methods of manufacturing a heat exchanger.

Heat exchangers are devices built for transferring heat from one fluid to another. The fluids may be separated by a solid wall or other divider that keeps them from mixing. Heat exchangers are commonly used in refrigeration, air conditioning, space heating, electricity generation, and chemical processing. Heat exchangers are of particular use in the aerospace and automobile industries.

For efficiency, heat exchangers are designed to maximize the surface area of the wall between the two fluids, while minimizing resistance to fluid flow through the heat exchanger. The performance of the heat exchanger may also be affected by the addition of fins, corrugations or other forms of protuberances in one or both flow directions which increase surface area, channel fluid flow, and induce turbulence.

Known methods of manufacturing heat exchangers involve complex assembly and multiple steps of attachment, brazing, soldering, or welding operations of the various parts of the heat exchangers, including but not limited to, the core, the exterior, fins, and manifolds for example. Known heat exchangers are typically made from sheet metal. The cost of manufacturing heat exchangers using the above described methods is high due to the complex assembly operations and the maintenance of tools to conduct the assembly operations.

### BRIEF DESCRIPTION OF THE INVENTION

According to one embodiment of the invention, a method of creating a heat exchanger for use with a rotating component configured to rotate about an axis of rotation is provided, including generating a stereolithography file of the surface geometry of the heat exchanger. The surface geometry of the heat exchanger includes a cylindrical base having a plurality of fins extending generally radially therefrom. The surface geometry of the stereolithography file is digitally sliced into a plurality of axisymmetric layers, perpendicular to the axis of rotation. Energy from an energy source is applied to a powdered material causing the powdered material to fuse and form the plurality of axisymmetric thin layers. Each of the axisymmetric thin layers is integrally formed with an adjacent axisymmetric thin layer to create a unitary heat exchanger.

Alternatively, in this or other aspects of the invention, a portion of each of the plurality of fins is skewed relative to the axis of rotation.

Alternatively, in this or other aspects of the invention, the first end of each of the plurality of fins is skewed.

Alternatively, in this or other aspects of the invention, the plurality of fins is skewed over the entire length of the heat exchanger.

Alternatively, in this or other aspects of the invention, the integrally formed axisymmetric thin layers are heat treated.

Alternatively, in this or other aspects of the invention, the integrally formed axisymmetric thin layers are coated.

Alternatively, in this or other aspects of the invention, the energy source is an electron beam.

Alternatively, in this or other aspects of the invention, the energy source is a laser.

Alternatively, in this or other aspects of the invention, the powdered metal is selected from metal, metal alloy, ceramic, and a composite material.

Alternatively, in this or other aspects of the invention, each of the plurality of axisymmetric thin layers is formed sequentially.

According to an alternate embodiment of the invention, a heat exchanger configured for use with a rotating component about an axis of rotation is provided including a generally cylindrical base. A plurality of fins is integrally formed with and extends generally radially from the base such that the heat exchanger is substantially axisymmetric about the axis of rotation. A portion of each of the plurality of fins is skewed relative to the axis of rotation.

Alternatively, in this or other aspects of the invention, the plurality of fins extends generally radially outward from the first surface of the base.

Alternatively, in this or other aspects of the invention, the plurality of fins extends generally radially inward from the second surface of the base.

Alternatively, in this or other aspects of the invention, each of the plurality of fins is substantially identical.

Alternatively, in this or other aspects of the invention, the plurality of fins extends from a first end of the base to a second, opposite end of the base.

Alternatively, in this or other aspects of the invention, the plurality of fins is skewed about the axis of rotation. The skew of the fins extends from the first end of the base to the second end of the base.

Alternatively, in this or other aspects of the invention, the size and/or shape of each of the plurality of fins is substantially constant.

Alternatively, in this or other aspects of the invention, the size and/or shape of each of the plurality of fins varies relative to the base.

Alternatively, in this or other aspects of the invention, the size and/or shape of each of the plurality of fins, the size and/or shape of each of the plurality of fins varies from the first end of the base to the second end of the base.

Alternatively, in this or other aspects of the invention, the plurality of fins is skewed adjacent a first end of the base.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-section of a heat exchanger according to an embodiment of the invention;

FIG. 2 is a cross-section of a heat exchanger according to an embodiment of the invention;

FIG. 3 is a perspective view of the heat exchanger illustrated in FIG. 2;

FIG. 4 is a side view of a heat exchanger according to an embodiment of the invention; and

FIG. 5 is a method of manufacturing a heat exchanger according to an embodiment of the invention.

The detailed description explains embodiments of the invention, together with advantages and features, by way of example with reference to the drawings.

### DETAILED DESCRIPTION OF THE INVENTION

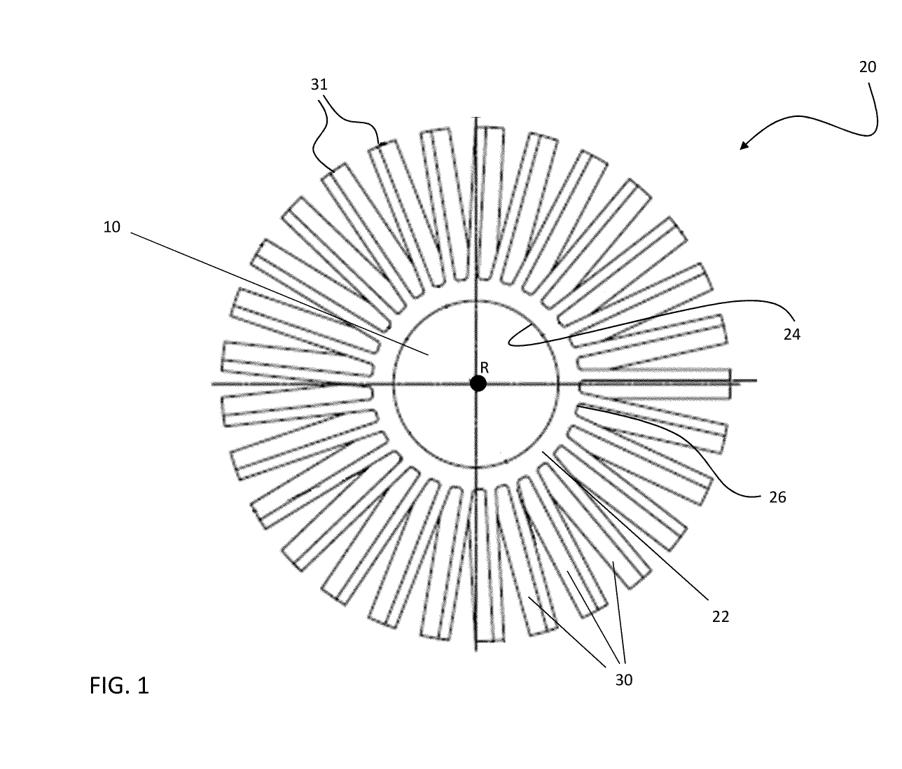

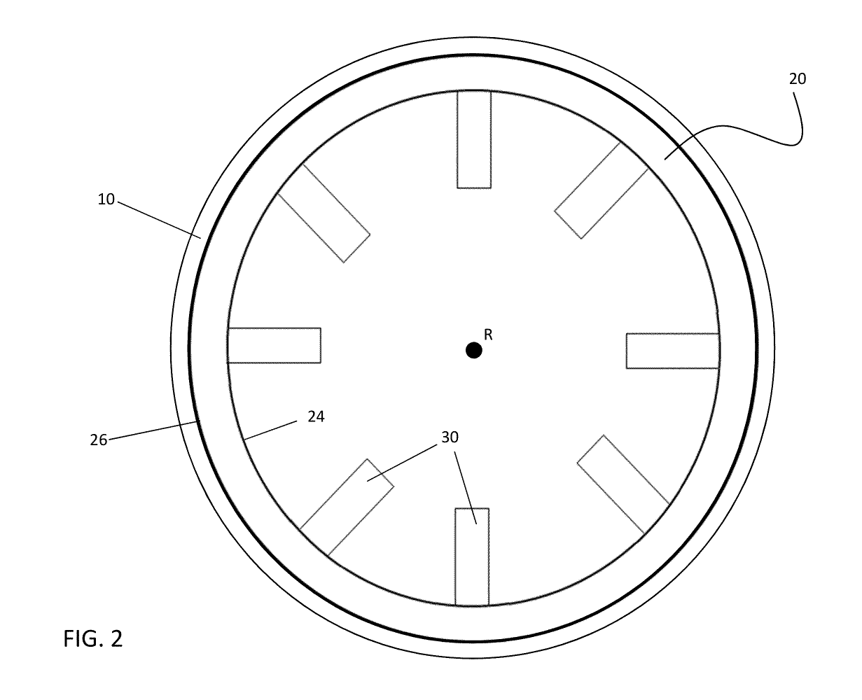

Referring now to the FIGS., a heat exchanger 20 configured for use with a rotating component 10, such as a motor driven shaft for example, is illustrated. The heat exchanger 20 includes a generally cylindrical base 22 having a plurality of fins 30 extending generally radially therefrom. Each of the plurality of fins 30 is spaced apart from another of the plurality of fins 30. In one embodiment, the heat exchanger 20 is substantially axisymmetric about the axis of rotation R of the rotating component 10. As illustrated in FIG. 1, a first surface 24 of the base 22 may be positioned adjacent to the rotating component 10 such that the plurality of fins 30 extends generally outwardly from a second, opposite surface 26 of the base 22. A generally cylindrical element (not shown) may be arranged adjacent and connected to the distal ends 31 of the fins 30. In another embodiment, the second surface 26 of the base 22 may be arranged adjacent to the rotating component 10 such that the plurality of fins 30 extends generally inwardly from the first surface 24 of the base as is illustrated in FIG. 2.

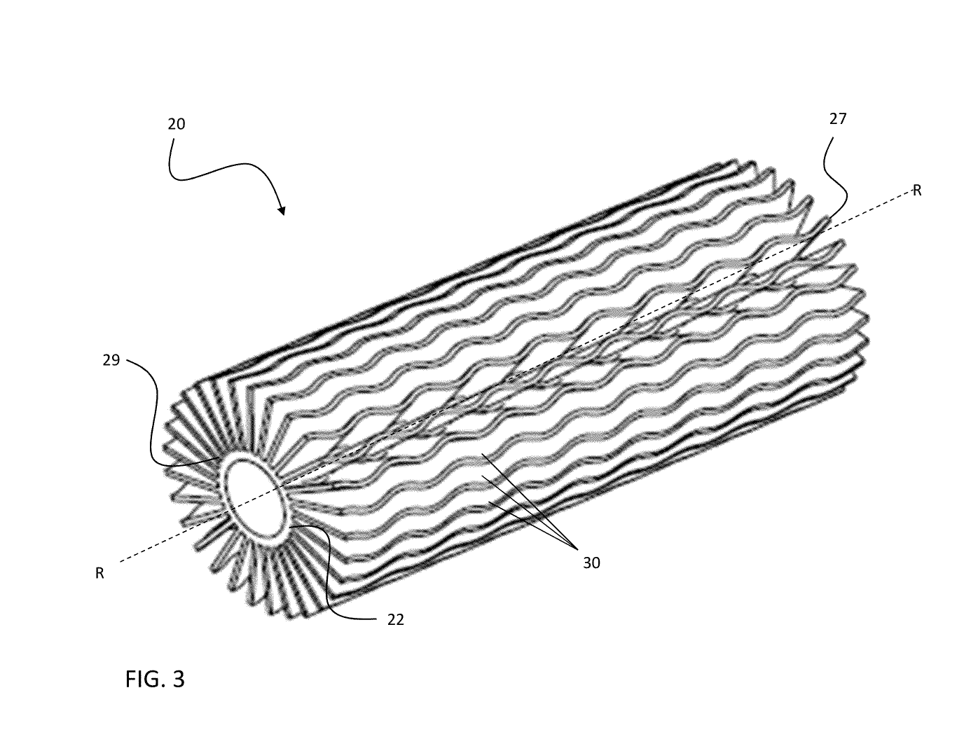

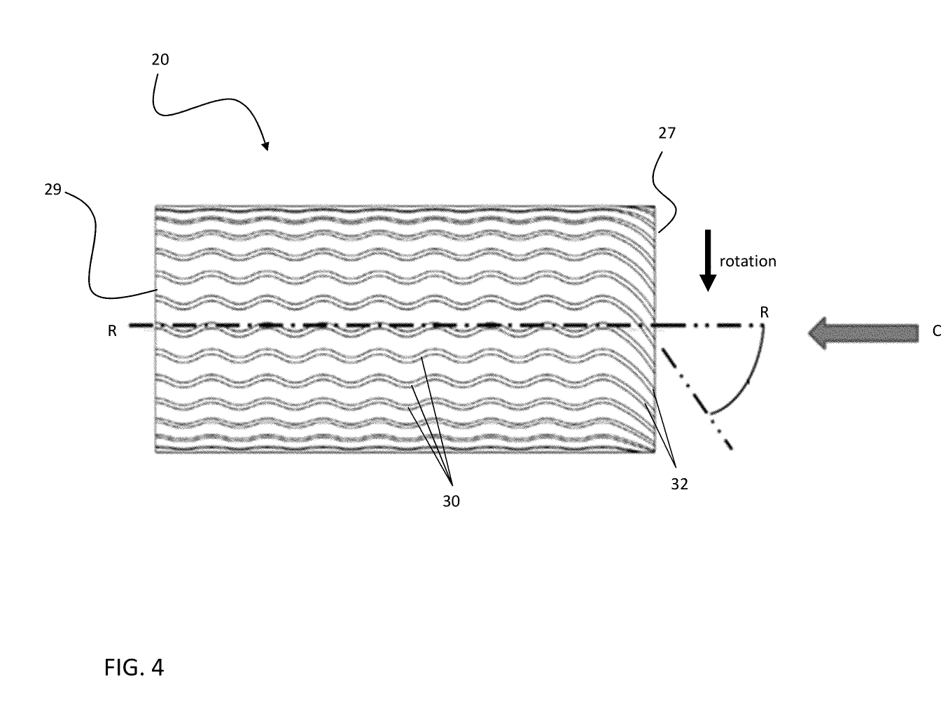

In one embodiment, each of the plurality of fins 30 is configured to extend generally longitudinally along the base 22, such as from a first end 27 to a second, opposite end 29. The plurality of fins 30 may, but need not be, substantially identical from end 27 to end 29 as shown in FIG. 3. In addition, the size and/or shape of each of the plurality of fins 30 may be generally constant. Alternatively, the size and/or shape of at least one of the plurality of fins 30 may vary about the periphery of the base 22 or over the length of the base 22 (FIG. 4). In one embodiment, illustrated in FIG. 4, a portion of the each of the plurality of fins 30, such as an inlet end 32 for example, is skewed relative to the axis of rotation R to create a pumping mechanism and enhance the cooling flow C over the fins 30 during rotation of the rotating member 10 about axis R. In another embodiment, at least one of the plurality of fins 30 may be skewed over the entire length of the fin 30 such that the fin 30 wraps around the cylindrical base 22.

In one embodiment, the heat exchanger 20 is formed through an additive metal fabrication process that applies energy to a generally powdered material, such as a powered metal, metal alloy, ceramic or composite material for example, to form a shape. Exemplary additive metal fabrication processes include, but are not limited to, direct metal laser sintering (DMLS), selective laser sintering (SLS), and electron beam melting (EBM) for example.

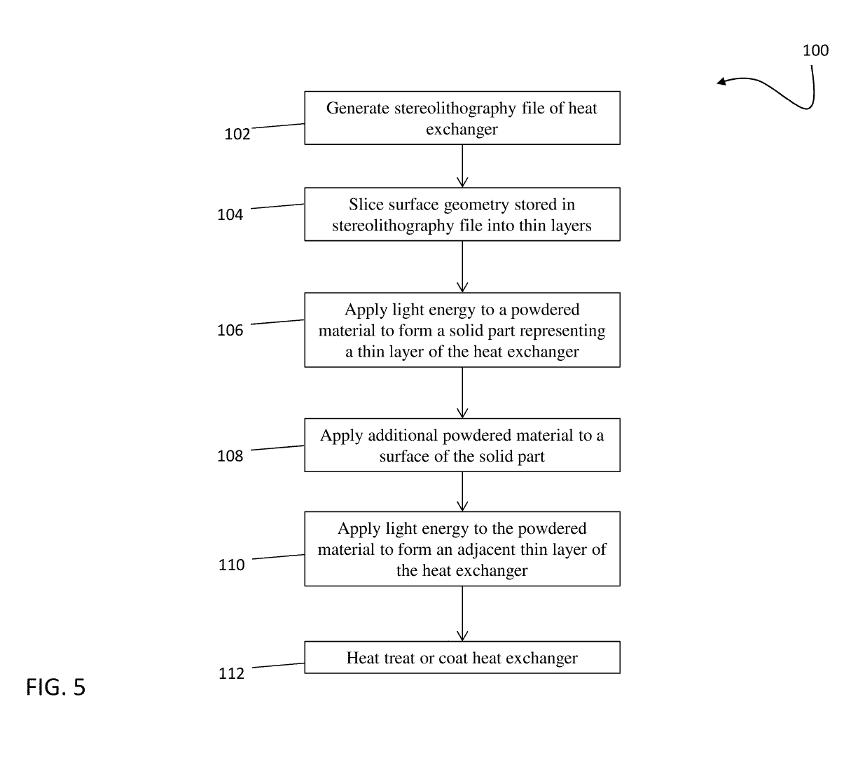

Referring now to FIG. 5, a method 100 of fabricating a heat exchanger 20 is described. In block 102, a stereolithography file that describes the surface geometry of the heat exchanger 20 is generated, for example based on a three dimensional model of the heat exchanger 20 created using a computer aided design (CAD) software. The stereolithography file is provided as an input to a pre-processing software configured to slice the surface geometry of the heat exchanger 20 into a plurality of thin layers, as illustrated in block 104. In one embodiment, because the heat exchanger 20 is substantially axisymmetric, each of the plurality of thin layers will similarly be axisymmetric about the axis of rotation R. The thickness of each of the plurality of thin layers will vary depending on the specific additive metal fabrication process used, as well as the size of the heat exchanger 20. For example, if the heat exchanger 20 is fabricated using direct metal laser sintering, the plurality of layers may have a thickness of about 20 micrometers, whereas if the heat exchanger 20 is fabricated using electron beam melting, the plurality of layers may have a thickness of about 40 micrometers.

In block 106, after the model of the heat exchanger 20 has been sliced into a plurality of layers, energy from an energy source is applied to a powdered material on a surface, such as a build platform for example. Examples of the energy source, include but are not limited to, an electron beam, a laser, or any other suitable light source known to a person having ordinary skill in the art for example. The energy or heat from the energy source locally melts the powdered material such that the powdered material fuses into a substantially solid part to create a generally two-dimensional section representing a thin layer of the heat exchanger 20. Additional powdered material is arranged on a surface of the fused solid part in block 108. Similar to block 106, in block 110, energy from the energy source is again applied to the powered material to form an adjacent thin layer of the heat exchanger 20. The addition of powered material in block 108 and the application of energy to the powered material in block 110, is generally repeated until each of the plurality of thin layers of the heat exchanger model has been created. Because the layers of the heat exchanger 20 are built sequentially, each thin layer is integrally formed with at least one adjacent thin layer to form a unitary heat exchanger 20. In one embodiment, the heat exchanger 20 may be heat treated to eliminate residual stresses in the heat exchanger 20, as illustrated in block 112. In another embodiment, a protective coating may be applied to the heat exchanger 20, in block 112, based on the intended application of the heat exchanger 20.

By forming a heat exchanger 20 using an additive metal fabrication process, the heat exchanger 20 may be formed as a single component and does not require the assembly of separate parts, or the rolling and aligning of fins to form an axisymmetric configuration. In addition, fabrication using an additive process is offers significant advantages over conventional methods in both production time and cost. For example, the heat exchanger 20 may be fabricated using materials, such as nickel for example, that would not be suitable using conventional methods because of cost and inefficiencies. In addition, building the heat exchanger by additive manufacturing process eliminates the brazing operation, and therefore the unse of any undesirable materials. Because the heat exchanger 20 is built layer by layer, it is possible to customize a heat exchanger 20 to an application, such as by including non-uniform features or passages that could not previously be cast or machined. For example, the fins 30 of the heat exchanger 20 may be formed with a thickness less than, or considerably more than if the heat exchanger 20 was formed by folding a piece of sheet metal.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of creating a heat exchanger for use with a rotating component configured to rotate about an axis of rotation, comprising:
generating a stereolithography file including a surface geometry of the heat exchanger that includes a cylindrical base having a plurality of fins extending radially from the base,
slicing the surface geometry of the stereolithography file into a plurality of axisymmetric layers perpendicular to the axis of rotation;
applying energy from an energy source to a powdered material such that the powdered material fuses to form the plurality of axisymmetric thin layers, wherein each of the axisymmetric thin layers is integrally formed with an adjacent axisymmetric thin layer to create a unitary heat exchanger.

2. The method according to claim 1, wherein a portion of each of the plurality of fins is skewed relative to the axis of rotation.

3. The method according to claim 2, wherein a first end of each of the plurality of fins is skewed.

4. The method according to claim 2, wherein the plurality of fins is skewed over an entire length of the heat exchanger.

5. The method according to claim 1, further comprising heat treating the plurality of integrally formed axisymmetric thin layers.

6. The method according to claim 1, further comprising applying a coating to the plurality of integrally formed axisymmetric thin layers.

7. The method according to claim 1, wherein the energy source is an electron beam.

8. The method according to claim 1, wherein the energy source is a laser.

9. The method according to claim 1, wherein the powdered material is selected from metal, metal alloy, ceramic and a composite material.

10. The method according to claim 1, wherein each of the plurality of axisymmetric thin layers is formed sequentially.

11. A heat exchanger configured for use with a rotating component about an axis of rotation is provided, comprising:
a generally cylindrical base having a plurality of fins integrally formed with and extending generally radially from the base, such that the heat exchanger is substantially axisymmetric about the axis of rotation, wherein a portion of each of the plurality of fins is skewed relative to the axis of rotation.

12. The heat exchanger according to claim 11, wherein the plurality of fins extend generally radially outward from a first surface of the base.

13. The heat exchanger according to claim 11, wherein the plurality of fins extend generally radially inward from a second surface of the base.

14. The heat exchanger according to claim 11, wherein the plurality of fins are substantially identical.

15. The heat exchanger according to claim 11, wherein the plurality of fins extend from a first end of the base to a second, opposite end of the base.

16. The heat exchanger according to claim 15, wherein the plurality of fins are skewed about the axis of rotation from the first end of the base to the second end of the base.

17. The heat exchanger according to claim 11, wherein a size and/or shape of each of the plurality of fins is substantially constant.

18. The heat exchanger according to claim 11, wherein a size and/or shape of each of the plurality of fins varies relative to the base.

19. The heat exchanger according to claim 11, wherein a size and/or shape of each of the plurality of fins varies from a first end of the base to a second, opposite end of the base.

20. The heat exchanger according to claim 11, the plurality of fins are skewed adjacent a first end.
